(19) United States
(12) Patent Application Publication
(10) Pub. No.: US 2006/0036499 A1
(43) Pub. Date: Feb. 16, 2006

(54) Inventory management system and method

(76) Inventor: Jennifer Leu, Fremont, CA (US)

Correspondence Address: THOMAS, KAYDEN, HOSTEMEYER & RISLEY LLP, 100 GALLERIA PARKWAY, SUITE 1750, ATLANTA, GA, 30339, US

(21) Appl. No.: 10/897,132

(22) Filed: Jul. 22, 2004

(51) Int. Cl. G06F 17/50

(52) U.S. Cl. 705/15; 705/8; 705/7

(57) ABSTRACT

A system for inventory management. The system contains an input/output device, a processor, and a storage device. The input/output device receives client, current inventory, purchase order, and backorder information pertaining to an article. The processor generates a hierarchy of clients according to the client information, determines an availability-to-promise of the article according to the hierarchy and the information of current inventory, purchase order, and backorder. The storage device stores the hierarchy and the client, current inventory, purchase order, and backorder information.

### BACKGROUND

The present invention relates to inventory management and particularly to an inventory management system determining availability-to-promise (ATP) of an article.

In a complex manufacturing environment such as semiconductor manufacturing, it is very difficult to determine the availability of components/parts. Currently existing planning tools used for determining availability include spreadsheets and manual calculations. Spreadsheets are commonly used to combine supply and demand information for managing parts and components, and for making reasonably accurate product forecasts.

Most current tools use calculator-like logic to determine part availability for each client. Typically, part availability is determined by subtracting demand and reservations from total supply. According to the conventional availability-to-promise (ATP) determination, the total supply comprises inventory from demand forecast of different clients, and demands are filled on a first-come-first-serve basis.

As mentioned above, in conventional ATP determination, all clients are considered equal, and commitments are made on a first-come-first-serve basis. The conventional ATP determination does not make distinctions between demands from clients with and without proper demand forecasts. Clients A, B, and C put forward demand forecasts of 300, 200, and 500 units of part X, respectively. Then a purchase order for 1000 units of part X is submitted according to the order forecast. Meanwhile, a stock of 1000 units of part X is reserved in a warehouse. A client D, having given no demand forecast, ordering 400 units of part X, receives an availability-to-promise of 400 units of part X based on a first-come-first-serve basis. Then clients B and C order 200 and 400 units of part X consequently, and get an availability-to-promise of 200 and 400 units accordingly. Client A, having a 300-unit demand forecast, does not place an order for part X at this time. Based on the first-come-first-serve basis, clients D, B, and C obtain ATP of 400, 200, and 400 units of part X, respectively. When client A places an order at a later date, there is no stock of part X and must wait for stock replenishment. Therefore, inventory kept for client A' s 300-unit demand forecast is appropriated by client D. Furthermore, the conventional ATP determination does not have any capability of prioritizing demands, thus on-hand inventory cannot be reserved for clients having proper demand forecast.

Additionally, conventional inventory management systems allocate inventory on a first-come-first-serve basis by client identification numbers regardless of the entity represented by a particular client identification number. Business relationships cannot be accommodated on the basis of client identification numbers. For example, one organization may have several branches corresponding to different client identification numbers. It is difficult for the conventional inventory management to manage inventory of a group of business entities at an aggregated level. Using FIG. 1 as an example, client information 100 is stored and managed using a corresponding client identification number, and the client identification number is normally a serial number given in sequential order. Therefore, the client identification number has no reference to business relationships in reality. One client having several business units may in fact comprise several unrelated client identification numbers, for example, IBM PC unit is given a client identification number of 1234, IBM-Celestic is given a client identification number of 3390, and IBM server a client identification number of 1255. In the conventional inventory management system, the inventory information of the IBM company as a whole cannot be managed in an aggregated level.

Using FIG. 1C as an example, IBM PC (ID No. 1234), IBM Server (ID No. 1255), CISCO (ID No. 5528), HP printer (ID No. 3215), and Nvidia (ID No. 2270) provide a demand forecast for part X of 100, 100, 150, 350, and 300 units, respectively. According to the demand forecast, a corresponding purchase order for part X has been placed with planned receipt dates of Jun. 1, 2003, Jun. 1, 2003, Jun. 15, 2003, Jun. 15, 2003, Jun. 18, 2003, respectively. At the time of availability-to-promise (ATP) checking on May 31, 2003, there are 1000 units of part X in stock. The aforementioned client entities have placed orders for part X. HP printer has ordered 800 units of part X with a planned ship date of Jul. 1, 2003. IBM PC has ordered 100 units of part X with a planned ship date of Jul. 15, 2003. CISCO has ordered 150 units of part X with a planned ship date of Jul. 15, 2003. Nvidia has ordered 300 units of part X with a planned ship date of Jul. 15, 2003. As discussed, a conventional inventory management system performs ATP checking for a particular client entity without any regard to demand forecasts from the client entity or corresponding purchase orders placed for the client entity at a prior time. The availability-to-promise is calculated by subtracting unfilled demand from inventory, wherein the inventory comprises on-hand and in-transit inventory, and the unfilled demand is the backorder. Because the backorder is filled on a first-come-first-serve basis, the backorder from HP printer (ID No. 3215) is filled first. As a result, the ATP for HP printer is 800 units, exceeding the corresponding demand forecast and purchase order. The ATP for IBM PC is 100 units, equaling the corresponding demand forecast and purchase order. The ATP for CISCO is 100 units, less than the corresponding demand forecast and purchase order. The ATP for Nvidia is zero, while the actual demand, demand forecast, and corresponding purchase order is 300 units. The demand of HP printer is filled in spite of its insufficient demand forecast. On the other hand, while CISCO and Nvidia have placed proper demand forecast, the parts purchased for them are diverted to fill the demand of HP printer because of its earlier ship date.

Hence, there is a need for an inventory management system which addresses the problems arising from the existing technology.

### SUMMARY

It is therefore an object of the invention to provide a system and method of inventory management to improve the handling of availability-to-promise for different clients.

To achieve this and other objects, the present invention provides a system and method of inventory management capable of managing inventory for different clients.

The present invention provides a system for inventory management comprising an input/output device, a processor, and a storage device. The input/output device receives client, current inventory, purchase order, and backorder information pertaining to an article. The processor generates a hierarchy of clients according to the client information, determines an availability-to-promise for the article according to the hierarchy and the information of current inventory, purchase order, and backorder. The storage device stores the hierarchy and the information.

The hierarchy, comprising at least one client lineage comprising at least one client entity, corresponds to a particular organization comprising at least one unit.

The present invention also provides a computer implemented method for inventory management. First, information for clients placing demands for an article is provided. Second, current inventory, purchase order, current demand, and backorder information pertaining to the article is provided. Then a hierarchy of clients is generated according to the client information. When a client places an order for the article, an availability-to-promise for the article is generated according to the hierarchy, current inventory, purchase order, current demand, and backorder. Thus, the availability-to-promise corresponding to the order of the client is calculated on the basis of the hierarchy, and the inventory for different clients is managed respectively.

The above-mentioned method may take the form of program code embodied in a tangible media. When the program code is loaded into and executed by a machine, the machine becomes an apparatus for practicing the invention.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIGS. 1A to 1B illustrate conventional inventory management operation;

FIG. 2 is a schematic view of an inventory management system according to the present invention;

FIG. 3 is a flowchart of the inventory management method of the system of FIG. 2;

FIG. 4 illustrates a hierarchy of client entities according to the present invention;

FIG. 5 illustrates ATP determination according to the embodiment of the present invention; and

FIG. 6 is a diagram of a storage medium storing a computer program providing the inventory management method.

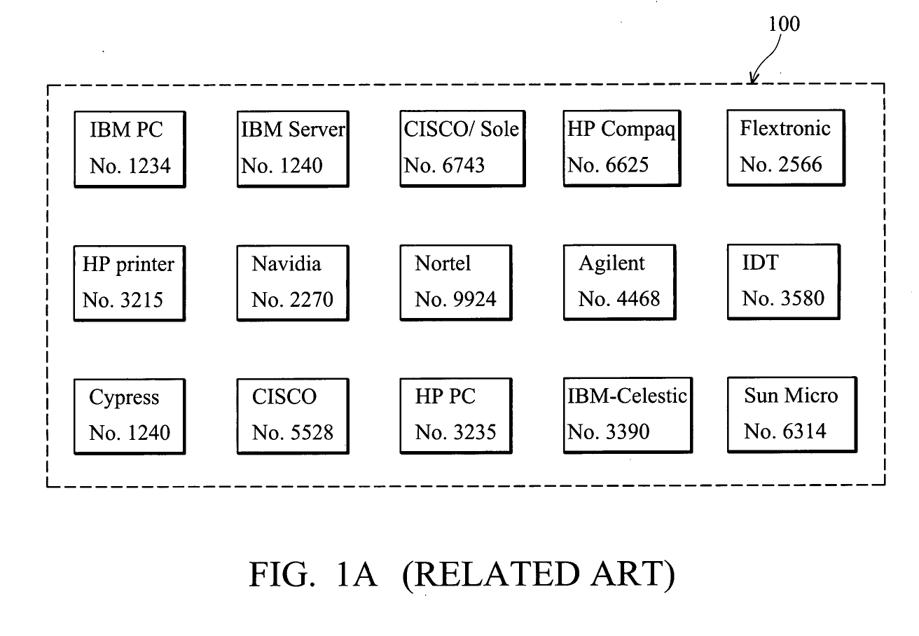

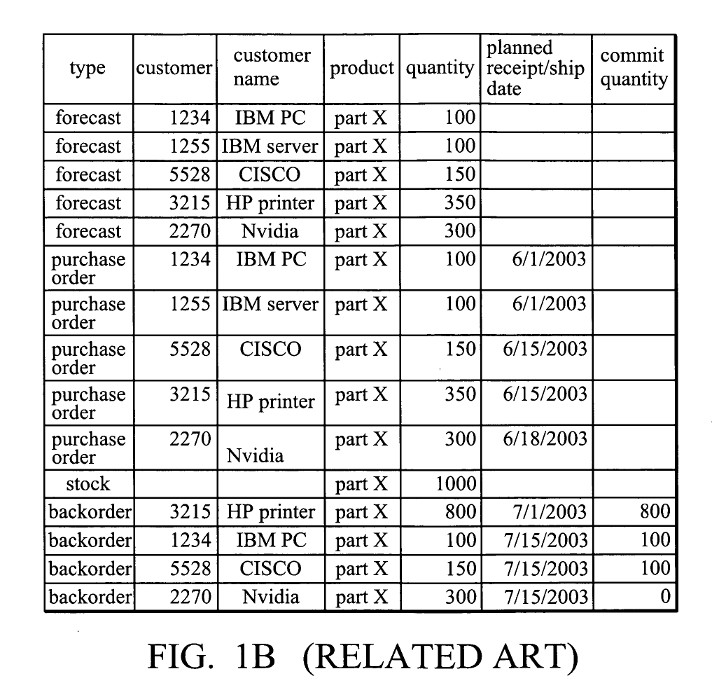

### DETAILED DESCRIPTION

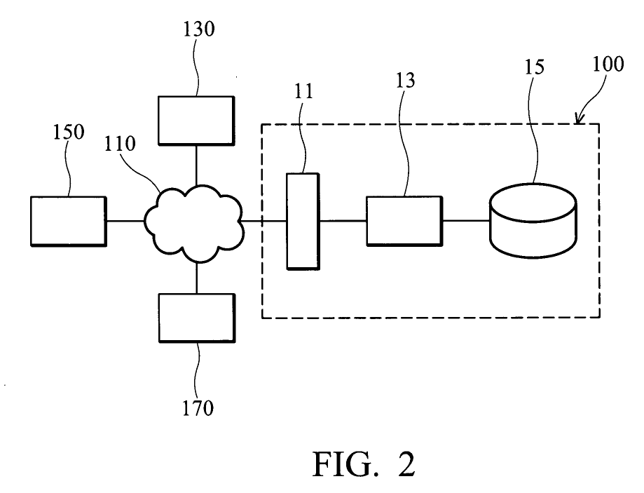

The present invention is be described with reference to FIGS. 2 to 6, in general relating to an inventory management system. While the preferred embodiment of the invention operates in the semiconductor fabricating industry, it is understood that the type of article stocked in the fabricating system is not critical to the present invention, and any fabricating system using numerous components or parts may operate with the present invention.

FIG. 2 is a schematic view of an inventory management system according to the present invention. The inventory management system 100 contains an input/output device 11, a processor 13, and a storage device 15. The input/output device 11 is connected to an order management center 130, a purchase management center 150, and a storage management center 170 through a network 110. The input/output device 11 receives inventory information from the storage management center 170, wherein the inventory information specifies current inventory of a particular article. The input/output device 11 receives demand information pertaining to the article from the order management center 130, wherein the demand information specifies backorder, i.e. the unfilled demand, for the article. The input/output device 11 receives purchase information pertaining to the article from the purchase management center 150, wherein the purchase information specifies received purchase orders for the article. The processor 13 generates a hierarchy of clients according to the client information, wherein the hierarchy specifies relationships between client entities represented by different client identification numbers. The storage device 15 stores the hierarchy and the current inventory, purchase order, and backorder information When receiving an order from a particular client, the processor 13 determines an availability-to-promise for the article for the client according to the hierarchy and current inventory, purchase order, and backorder information. The hierarchy comprises at least one client lineage comprising at least one client entity, wherein the client lineage corresponds to a particular organization comprising at least one branch. Each client entity has a client identification number.

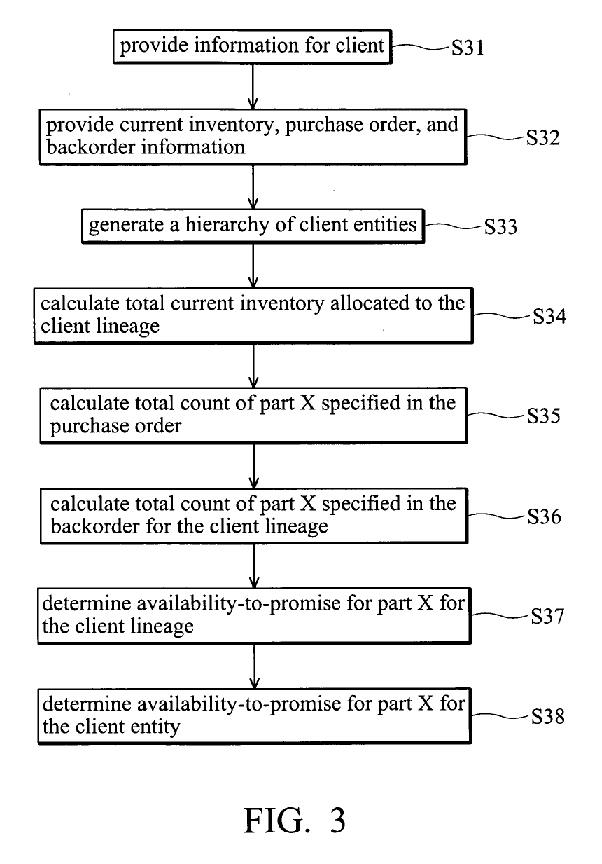

FIG. 3 is a flowchart of the inventory management method of the system described above.

First, information for client placing demands for part x is provided (step S31). The client information contains a client identification number and a client name.

Second, current inventory, purchase order, and backorder information pertaining to the part X is provided (step S32). The current inventory information specifies the amount of inventory for part X kept in a warehouse as safety stock. The purchase order information specifies quantities of part X purchased but not yet received at the warehouse, practically assessed as goods-in-transit, which is integrate into the safety stock at a chosen time. The backorder information specifies unfilled demands for part X.

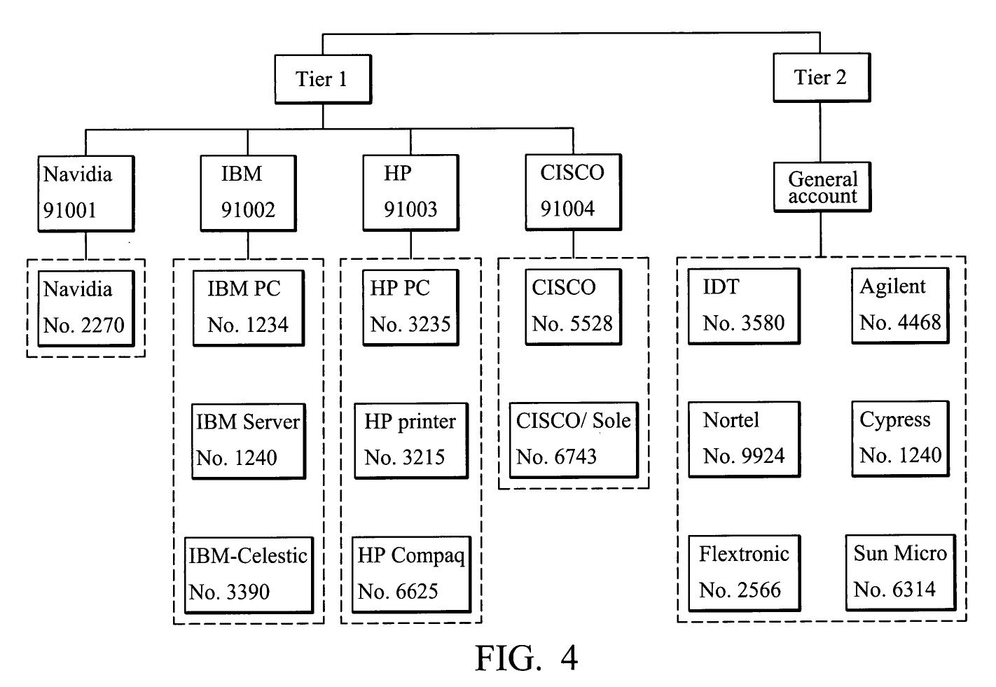

A hierarchy of client entities is generated according to the client information (step S33). The hierarchy, comprising at least one client lineage having at least one client entity, corresponds to a particular organization comprising at least one unit. FIG. 4 shows the hierarchy of client entities mentioned. The client lineage corresponding to a particular organization is issued a lineage identification number, and each client entity is issued a client identification number. For example, client entities related to IBM are grouped into an IBM lineage. The IBM lineage is issued a lineage identification number of 91002 and comprises three client entities: IBM PC (ID No. 1234) IBM Server (ID No. 1256), and IBM-Celestic (ID No. 3390). The client identification numbers of the client entities are issued sequentially. The client lineage is organized according to business relationships among the client entities. The hierarchy can be easily reorganized or updated to conform to actual relationships among client entities. Additionally, a plurality of client lineages can be grouped into a client tier, with different tiers assigned different priorities. Thus the hierarchy specifies relationship among client entities and priority for filling order therefrom.

When an order for part X is placed by a client entity, availability-to-promise for the part X for the client entity is generated according to the hierarchy and the current inventory, purchase order, and backorder information of the corresponding client lineage. In step S34, total current inventory allocated to the client lineage is calculated. In step S35, total count of part X specified in the purchase order for the client lineage is calculated. In step S36, total count of part X specified in the backorder for the client lineage is calculated. In step S37, availability-to-promise for part X for the client lineage is determined, wherein the availability-to-promise is obtained by subtracting count of backorder articles from current inventory and submitted purchase orders corresponding to the client lineage. In step S38, the availability-to-promise for a particular client entity of the client lineage is determined by subtracting the availability-to-promise of the remaining client entities from the availability-to-promise of the client lineage.

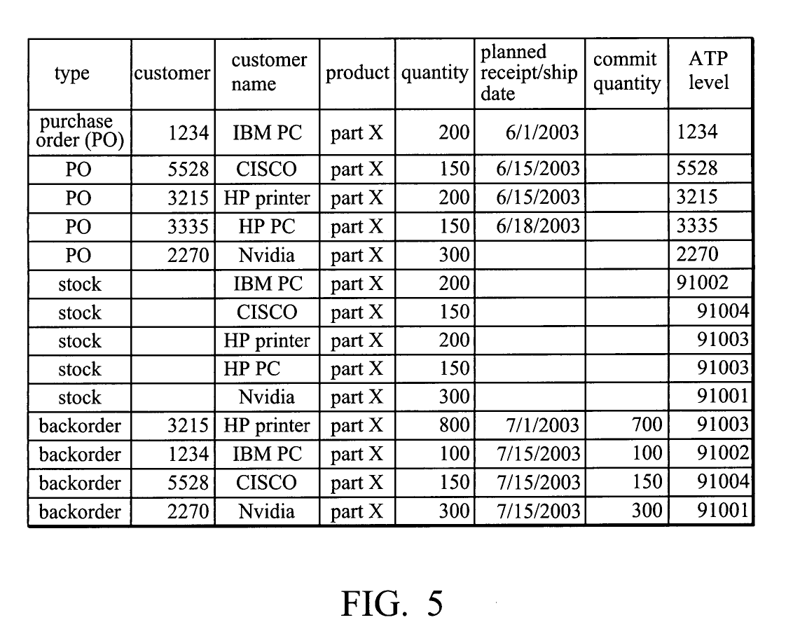

Using FIG. 5 as an example, purchase orders for IBM PC (ID No. 1234), CISCO (ID No. 5528), HP printer (ID No. 3215), HP PC (ID No. 3335), and Nvidia (ID No. 2270) are placed for part X for 200, 150, 200, 150, and 300 units, respectively, wherein the corresponding forecasted receipt dates are Jun. 1, 2003, Jun. 15, 2003, Jun. 15, 2003, Jun. 15, 2003, Jun. 18, 2003, respectively. The in-transit inventory derived from the aforementioned purchase order is dedicated to IBM PC (ID No. 1234), CISCO (ID No. 5528), HP printer (ID No. 3215), HP PC (ID No. 3335), and Nvidia (ID No. 2270), respectively. At the time of availability-to-promise (ATP) checking on May 31, 2003, there are 1000 units of part X in stock. The aforementioned client entities have placed orders for part X. The stock items are entitled to different client lineages according to the corresponding source of purchase orders. Among the 1000-unit on-hand inventory, there are 200, 150, 350, and 300 units of part X entitled to client lineage of IBM (ID No. 91002), CISCO (ID No. 91004), HP (ID No. 91003), and Nvidia (ID No. 91001). HP printer has ordered 800 units of part X with a forecasted ship date of Jul. 1, 2003. IBM PC has ordered 100 units of part X with a forecasted ship date of Jul. 15, 2003. CISCO has ordered 150 units of part X with a forecasted ship date of Jul. 15, 2003. Nvidia has ordered 300 units of part X with a forecasted ship date of Jul. 15, 2003. As discussed above, the inventory management system performs ATP checking for a particular client entity according to corresponding backorder and purchase order for the client entities of the corresponding client lineage at a prior time. The availability-to-promise is calculated by subtracting unfilled demand from inventory, wherein the inventory comprises on-hand and in-transit inventory, and the unfilled demand is the backorder. Because the in-transit and on-hand inventory is calculated based of client lineage, the backorder is filled using the inventory allocated to the client lineage. As a result, the ATP for HP printer is 700, calculated as follows:
ATP checking on May 31, 2003
HP printer (ATP 91003)
   ATP=(stock 91003)+(purchase order 91003)+purchase order3215)

Similarly, the ATP for IBM PC is 100, equaling the actual demand and corresponding purchase order. The ATP for CISCO is 150, equaling the actual demand and corresponding purchase order. The ATP for Nvidia is 300, equaling the actual demand and corresponding purchase order. The demand for HP printer is partially filled according to the inventory allocated thereto. On the other hand, backorders from IBM, CISCO and Nvidia are filled owing to their proper demand forecast and sufficient inventory.

The method of the present invention, or certain aspects or portions thereof, may take the form of program code (i.e. instructions) embodied in a tangible media, such as floppy diskettes, CD-ROMS, hard drives, or any other machine-readable storage medium, wherein, when the program code is loaded into and executed by a machine, such as a computer, the machine becomes an apparatus for practicing the invention. The methods and apparatus of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

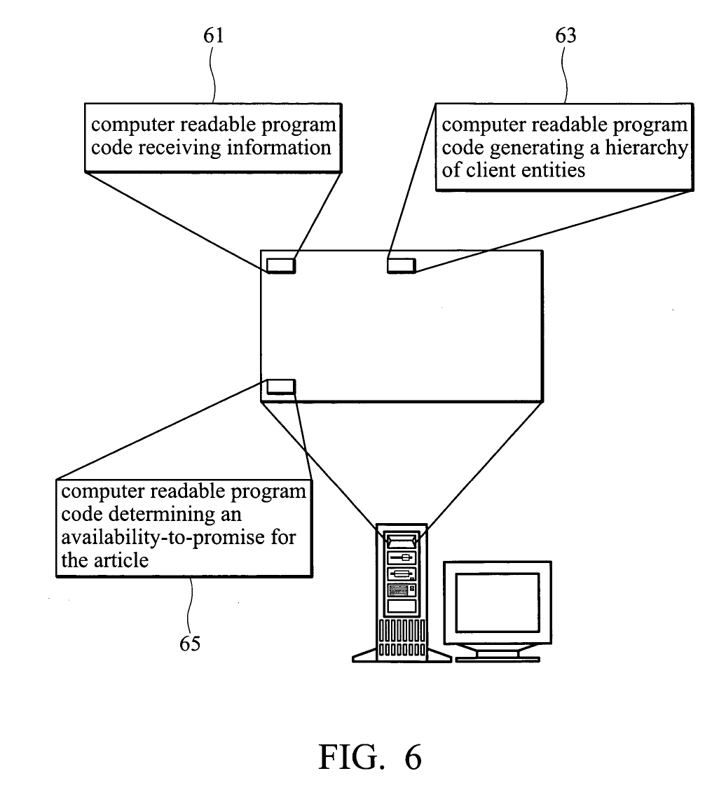

FIG. 6 is a diagram of a storage medium storing a computer program providing the inventory management method according to the present invention. The computer program product comprises a computer usable storage medium having computer readable program code embodied in the medium, the computer readable program code comprising computer readable program code 61 receiving client, current inventory, backorder, and purchase order information pertaining to the article, computer readable program code 63 generating a hierarchy of client entities according to the client information, and computer readable program code 65 determining an availability-to-promise for the article.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for inventory management, comprising:
an input/output device receiving current inventory, purchase order, and backorder information pertaining to an article;
a processor generating a hierarchy of client entities according to client information, and determining an availability-to-promise for the article according to the hierarchy and the information of current inventory, purchase order, and backorder; and
a storage device storing the hierarchy and the client, current inventory, purchase order, and backorder information.

2. The system of claim 1, wherein the hierarchy comprising at least one client lineage comprising at least one client entity corresponds to a particular organization comprising at least one unit.

3. The system of claim 2, wherein the processor further calculates total current inventory allocated to the client lineage.

4. The system of claim 2, wherein the processor further calculates the total count of the article specified in the purchase order for the client lineage.

5. The system of claim 2, wherein the processor further calculates the total count of the article specified by the backorder for the client lineage.

6. The system of claim 2, wherein the processor further determines availability-to-promise for the article for the client lineage by subtracting the amount of articles in the backorder from the current inventory and submitted purchase orders corresponding to the client lineage.

7. The system of claim 6, wherein the processor further determines the availability-to-promise for a particular client entity of the client lineage by subtracting the availability-to-promise of the remaining client entities from the availability-to-promise of the client lineage.

8. The system of claim 1, wherein the article is a component used in a manufacturing process.

9. A computer implemented method for inventory management, comprising:
providing information of client placing demands for an article;
providing current inventory, backorder, and purchase order information pertaining to the article;
generating a hierarchy of client entities according to the client information; and
determining an availability-to-promise for the article according to the hierarchy and current inventory, purchase order, and backorder information.

10. The method of claim 9, wherein the hierarchy comprising at least one client lineage comprising at least one client entity corresponds to a particular organization comprising at least one unit.

11. The method of claim 10, further calculating total current inventory allocated to the client lineage.

12. The method of claim 10, further calculating the total count of the article specified in the purchase order for the client lineage.

13. The method of claim 10, further calculating the total count of the article specified in the backorder for the client lineage.

14. The method of claim 10, further determining availability-to-promise for the article for the client lineage by subtracting amount of articles in the backorder from the current inventory and submitted purchase order corresponding to the client lineage.

15. The method of claim 10, further determining the availability-to-promise for a particular client entity of the client lineage by subtracting the availability-to-promise of the rest client entities from the availability-to-promise of the client lineage.

16. The method of claim 10, wherein the article is a component used in a manufacturing process.

17. A storage medium for storing a computer program providing a method for inventory management, the method comprising:
receiving information of client placing demands for an article;
receiving current inventory, backorder, and purchase order information pertaining to the article;
generating a hierarchy of client entities according to the client information; and
determining an availability-to-promise for the article according to the hierarchy and current inventory, purchase order, and backorder information.

18. The storage medium of claim 17, wherein the hierarchy comprising at least one client lineage comprising at least one client entity corresponds to a particular organization comprising at least one unit.

19. The storage medium of claim 17, wherein the method further calculates total current inventory allocated to the client lineage.

20. The storage medium of claim 17, wherein the method further calculates total amount of the article specified in the purchase order for the client lineage.

21. The storage medium of claim 17, wherein the method further calculates total amount of the article specified in the backorder for the client lineage.

22. The storage medium of claim 17, wherein the method further determines availability-to-promise of the article for the client lineage by subtracting amount of articles in the backorder from the current inventory and placed purchase order corresponding to the client lineage.

23. The storage medium of claim 17, wherein the method further determines availability-to-promise for a particular client entity of the client lineage by subtracting the availability-to-promise of the rest client entities from the availability-to-promise of the client lineage.
